(19) United States
(12) Patent Application Publication
(10) Pub. No.: US 2017/0262438 A1
(43) Pub. Date: Sep. 14, 2017

(54) SYSTEM AND METHOD FOR DETERMINING ANALYTICS BASED ON MULTIMEDIA CONTENT ELEMENTS

(71) Applicant: Cortica, Ltd., TEL AVIV (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/608,493

(22) Filed: May 30, 2017

Related U.S. Application Data
(63) Continuation-in-part of application No. 14/050,991, filed on Oct. 10, 2013.
Application No. 14/050,991 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/195,863 is a continuation-in-part of application No. 12/348,888, filed on Jan. 5, 2009.
(60) Provisional application No. 62/342,214, filed on May 27, 2016.
(60) Provisional application No. 62/343,875, filed on Jun. 1, 2016.
(60) Provisional application No. 61/860,261, filed on Jul. 31, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; G06Q 10/00

(52) U.S. Cl. CPC G06F 17/3002; G06F 17/30023; G06F 17/30595; G06F 17/30743; G06K 9/00711

(57) ABSTRACT

A system and method for determining analytics based on multimedia content elements. The method includes causing generation of at least one signature for at least one input multimedia content element, wherein each signature represents a concept, wherein each concept is a collection of signatures and metadata representing the concept; comparing the generated at least one signature to a plurality of signatures of reference multimedia content elements to determine at least one matching reference multimedia content element, wherein each reference multimedia content element is associated with at least one predetermined analytic; and determining, based on the comparison, at least one analytic, wherein the determined at least one analytic includes the at least one predetermined analytic associated with each matching reference multimedia content element.

### CROSS-REFERENCE TO RELATED APPLICATIONS

This application claims the benefit of U.S. Provisional Application No. 62/342,214 filed on May 27, 2016, and of U.S. Provisional Application No. 62/343,875 filed on Jun. 1, 2016. This application is also a continuation-in-part (CIP) of U.S. patent application Ser. No. 14/050,991 filed on Oct. 10, 2013, now pending, which claims the benefit of U.S. Provisional Application No. 61/860,261 filed on Jul. 31, 2013. The Ser. No. 14/050,991 application is also a CIP of U.S. patent application Ser. No. 13/602,858 filed on Sep. 4, 2012, now U.S. Pat. No. 8,868,619, which is a continuation of U.S. patent application Ser. No. 12/603,123, filed on Oct. 21, 2009, now U.S. Pat. No. 8,266,185. The Ser. No. 12/603,123 application is a CIP of:

(1) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006;

(2) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a CIP of the above-referenced U.S. patent application Ser. No. 12/084,150;

(3) U.S. patent application Ser. No. 12/348,888 filed on Jan. 5, 2009, now pending, which is a CIP of the above-referenced U.S. patent application Ser. Nos. 12/084,150 and 12/195,863; and

(4) U.S. patent application Ser. No. 12/538,495 filed on Aug. 10, 2009, now U.S. Pat. No. 8,312,031, which is a CIP of the above-referenced U.S. patent application Ser. Nos. 12/084,150; 12/195,863; and 12/348,888.

All of the applications referenced above are herein incorporated by reference for all that they contain.

### TECHNICAL FIELD

The present disclosure relates generally to the analysis of multimedia content, and more specifically to providing analytics based on an analysis of multimedia content elements.

### BACKGROUND

Many commercial establishments use various surveillance methods and techniques for security and analytics reasons, such as preventing theft and observing customer behavior. Security cameras are often employed to provide a video feed of a retail or commercial area to a viewing display. Many establishments install a plurality of such cameras located at various positions within an area to capture multiple viewpoints.

Existing solutions for surveilling areas include manual review of footage by, e.g., employees, as well as automated monitoring. Manual solutions face challenges particularly related to human error, as tedious observation may lead to boredom and overlooking of activities conducted by people in the surveilled area. Existing automated solutions face challenges in accurately identifying activities conducted by people in the surveilled area, particularly when distorting environmental features such as smoke and heat are present.

It would be therefore advantageous to provide a solution that overcomes the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is not intended to identify key or critical elements of all embodiments or to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining analytics based on multimedia content elements. The method includes causing generation of at least one signature for at least one input multimedia content element, wherein each signature represents a concept, wherein each concept is a collection of signatures and metadata representing the concept; comparing the generated at least one signature to a plurality of signatures of reference multimedia content elements to determine at least one matching reference multimedia content element, wherein each reference multimedia content element is associated with at least one predetermined analytic; and determining, based on the comparison, at least one analytic, wherein the determined at least one analytic includes the at least one predetermined analytic associated with each matching reference multimedia content element.

Certain embodiments disclosed herein also include a non-transitory computer readable medium having stored thereon causing a processing circuitry to execute a process, the process comprising: causing generation of at least one signature for at least one input multimedia content element, wherein each signature represents a concept, wherein each concept is a collection of signatures and metadata representing the concept; comparing the generated at least one signature to a plurality of signatures of reference multimedia content elements to determine at least one matching reference multimedia content element, wherein each reference multimedia content element is associated with at least one predetermined analytic; and determining, based on the comparison, at least one analytic, wherein the determined at least one analytic includes the at least one predetermined analytic associated with each matching reference multimedia content element.

Certain embodiments disclosed herein also include a system for determining analytics based on multimedia content elements. The system comprises: a processing circuitry; and a memory, the memory containing instructions that, when executed by the processing circuitry, configure the system to: cause generation of at least one signature for at least one input multimedia content element, wherein each signature represents a concept, wherein each concept is a collection of signatures and metadata representing the concept; compare the generated at least one signature to a plurality of signatures of reference multimedia content elements to determine at least one matching reference multimedia content element, wherein each reference multimedia content element is associated with at least one predetermined analytic; and determine, based on the comparison, at least one analytic, wherein the determined at least one analytic includes the at least one predetermined analytic associated with each matching reference multimedia content element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system utilized to describe the various embodiments disclosed herein.

FIG. 2 is a flowchart illustrating a method for determining analytics for multimedia content elements according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a schematic diagram of a MMCE analyzer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some disclosed features but not to others. In general, unless otherwise indicated, singular elements may be in plural and vice versa with no loss of generality. In the drawings, like numerals refer to like parts through several views.

The various disclosed embodiments include a system and a method for determining analytics based on input multimedia content elements. At least one input multimedia content element is received. Signatures are generated for the input multimedia content elements. The signatures generated for the input multimedia content elements are compared to signatures of a plurality of reference multimedia content elements. Each reference multimedia content element is associated with at least one analytic. At least one matching reference multimedia content element is determined based on the comparison. Analytics associated with each matching reference multimedia content element may be determined.

The analytics may indicate movements (e.g., movements within a target area, body movements, facial movements, etc.), interactions with objects in a target area, and the like. As non-limiting examples, the analytics may indicate, e.g., a particular path that a consumer takes when navigating a retail store, particular movements performed by individuals such as moving their head from side to side, the moving of merchandise by an individual, and similar observations of consumer behavior and actions. In some embodiments, the analytics may further include indications of one or more persons featured in the input multimedia content elements.

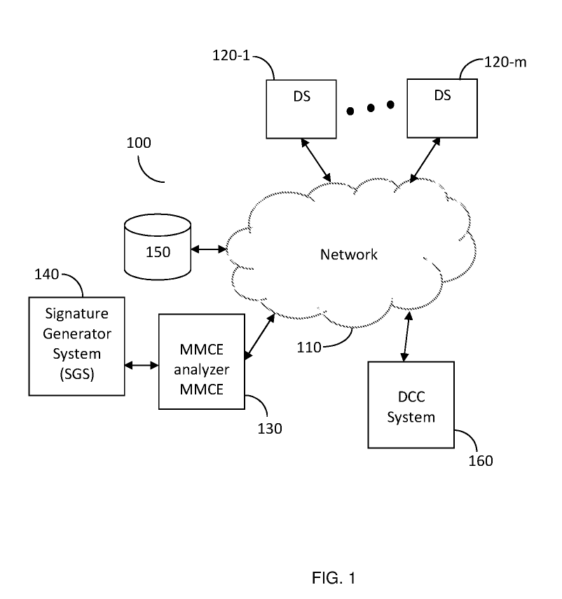

FIG. 1 shows an example network diagram 100 utilized to describe the various disclosed embodiments. The network diagram includes a plurality of data sources (DSs) 120-1 through 120-m (hereinafter referred to individually as a data source 120 and collectively as data sources 120, merely for simplicity purposes), a multimedia content element (MMCE) analyzer 130, a database 150, and a deep content classification (DCC) system 160. The network 110 may be the Internet, the world-wide-web (WWW), a local area network (LAN), a wide area network (WAN), a metro area network (MAN), and other networks capable of enabling communication between the elements of the network diagram 100.

A multimedia content element may include, for example, an image, a graphic, a video stream, a video clip, an audio stream, an audio clip, a video frame, a photograph, and an image of signals (e.g., spectrograms, phasograms, scalograms, etc.), a combination thereof, or a portion thereof.

The database 150 stores at least reference multimedia content elements, analytics associated with the reference multimedia content elements, and so on. In the example network diagram 100, the MMCE analyzer 130 communicates with the database 150 through the network 110. In other non-limiting configurations, the MMCE analyzer 130 may be directly connected to the database 150.

Each of the data sources 120 may store multimedia content elements for which analytics are to be generated. The multimedia content elements may include, but are not limited to, images and video captured via cameras deployed in stores or other areas to be surveilled, audio captured by microphones in areas to be surveilled, and the like. To this end, the data sources 120 may include, but are not limited to, servers or data repositories of entities such as, for example, entities owning surveilled areas, remote storage providers (e.g., cloud storage service providers), and any other entities storing multimedia content elements.

The signature generator system (SGS) 140 and the deep-content classification (DCC) system 160 may be utilized by the MMCE analyzer 130 to perform the various disclosed embodiments. Each of the SGS 140 and the DCC system 160 may be connected to the MMCE analyzer 130 directly or through the network 110. In certain configurations, the DCC system 160 and the SGS 140 may be embedded in the MMCE analyzer 130.

In an embodiment, the MMCE analyzer 130 is configured to receive at least one input multimedia content element, to generate at least one signature for each input multimedia content element, and to search for matching reference multimedia content elements based on the generated signatures. Each reference multimedia content element is associated with at least one predetermined analytics. The searching may be among reference multimedia content elements stored in, e.g., the database 150, one or more of the data sources 120, or both.

In an embodiment, the MMCE analyzer 130 is configured to send the input multimedia content elements to the signature generator system 140, to the deep content classification system 160, or both. In a further embodiment, the MMCE analyzer 130 is configured to receive a plurality of signatures generated for the input multimedia content elements from the signature generator system 140, to receive a plurality of signatures (e.g., signature reduced clusters) of concepts matched to the multimedia content element from the deep content classification system 160, or both. In another embodiment, the MMCE analyzer 130 may be configured to generate the plurality of signatures, identify the plurality of signatures (e.g., by determining concepts associated with the signature reduced clusters matching each input multimedia content element), or a combination thereof.

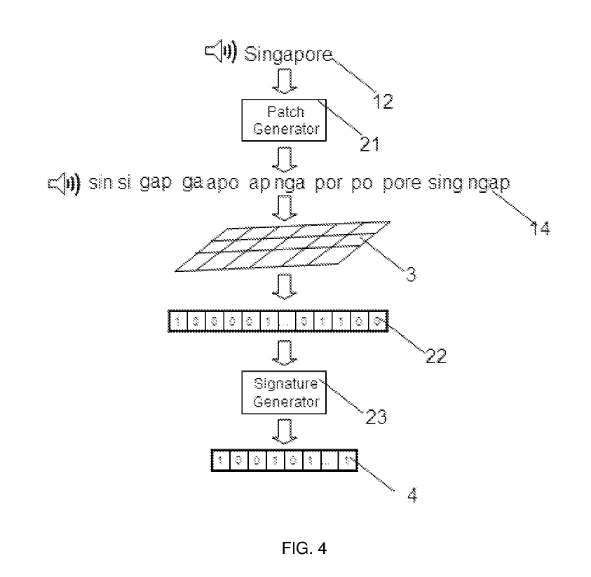

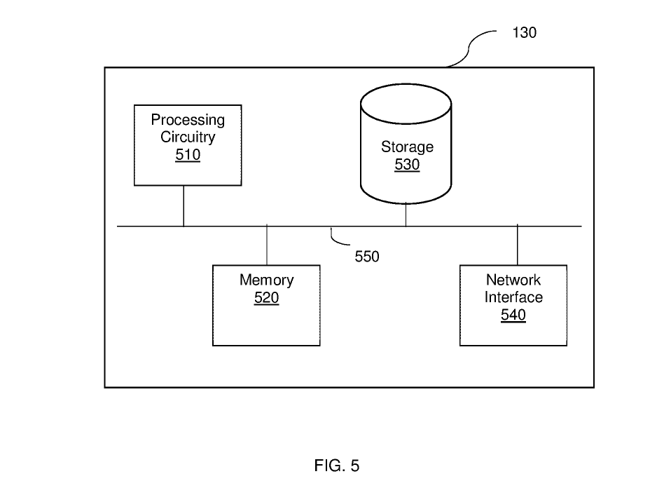

In an embodiment, determining the analytics based on an input multimedia content element includes causing generation of at least one signature for the input multimedia content element and comparing the generated at least one signature to a plurality of signatures generated for reference multimedia content elements stored in, e.g., the database 150 or data sources 120. Each reference multimedia content element is associated with at least one predetermined analytic such that analytics of the reference multimedia content element are likely to be appropriate for each matching input multimedia content element. In an embodiment, an input multimedia content element and a reference multimedia content element may be matching if signatures generated for the input multimedia content element match signatures of the reference multimedia content element above a predetermined threshold. The process of matching between signatures of multimedia content elements is discussed in detail herein below with respect to FIGS. 4 and 5.

Each signature represents a concept structure (hereinafter referred to as a “concept”). A concept is a collection of signatures representing elements of the unstructured data and metadata describing the concept. As a non-limiting example, a ‘Superman concept’ is a signature-reduced cluster of signatures describing elements (such as multimedia elements) related to, e.g., a Superman cartoon: a set of metadata representing proving textual representation of the Superman concept. Techniques for generating concept structures are also described in the above-referenced U.S. Pat. No. 8,266,185.

In another embodiment, the MMCE analyzer 130 is configured to determine the analytics by sending the input multimedia content elements to the DCC system 160 to match each input multimedia content element to at least one concept structure. If such a match is found, then the metadata of the concept structure may be used to generate the analytics. The identification of a concept matching the received multimedia content element includes matching at least one signature generated for the received element (such signature(s) may be produced either by the SGS 140 or the DCC system 160) and comparing the element's signatures to signatures representing a concept structure. The matching can be performed across all concept structures maintained by the system DCC 160.

It should be noted that, if the DCC system 160 returns multiple concept structures, a correlation for matching concept structures may be performed to generate an analytic that best describes the activity illustrated by the input multimedia content elements. The correlation can be achieved by identifying a ratio between signatures' sizes, a spatial location of each signature, and using the probabilistic models.

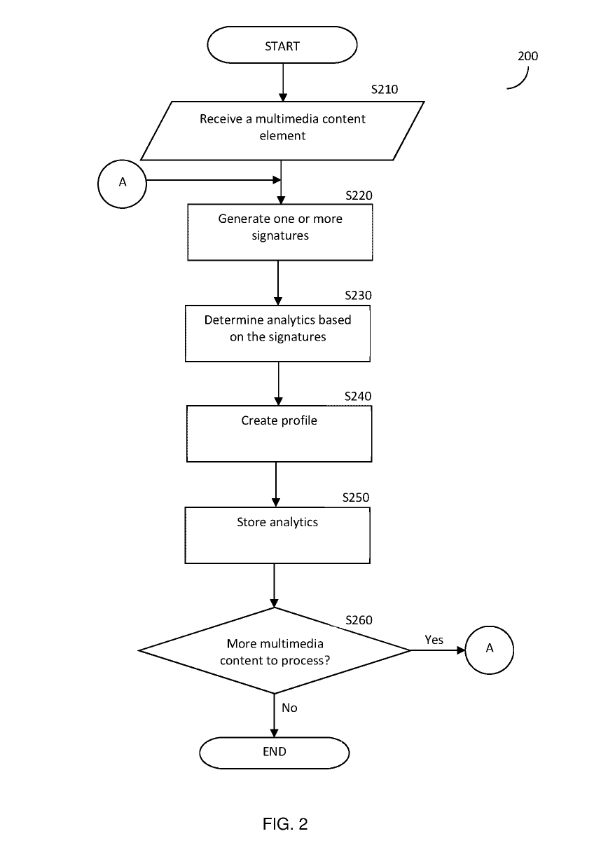

FIG. 2 depicts an example flowchart 200 describing a method for determining analytics for input multimedia content elements according to an embodiment. In an embodiment, the method may be performed by the multimedia content element analyzer 130, FIG. 1.

At S210, at least one input multimedia content element is received. Alternatively or collectively, the at least one input multimedia content element may be retrieved from, e.g., one or more sensors configured to capture multimedia content elements, one or more data sources, both, and the like.

At S220, at least one signature is generated for one of the input multimedia content elements. The signature(s) are generated by a signature generator system (e.g., the SGS 140) as described below with respect to FIGS. 4 and 5.

At S230, at least one analytic is determined based on the generated signatures. In an embodiment, S230 includes searching for at least one matching reference multimedia content element and identifying at least one analytic of the matching reference multimedia content element. Two signatures are determined to be matching if their respective signatures at least partially match (e.g., above a predetermined threshold). In another embodiment, S230 includes querying a DCC system with the generated signature or the input multimedia content element to identify at least one matching concept structure. The metadata of the matching concept structure is used to create analytic with respect to the received multimedia element.

Each of the analytics may indicate movements (e.g., movements within a target area, body movements, facial movements, etc.), interactions with objects in a target area, and the like. As non-limiting examples, the analytics may indicate, e.g., a particular path that a consumer takes when navigating a retail store, particular movements performed by individuals such as moving their head from side to side, the moving of merchandise by an individual, and similar observation of consumer behavior and actions. The analytics may be useful for, e.g., identifying suspicious behavior (e.g., shoplifting), identifying consumer preferences (e.g., types of products or particular products of interest to a user), and the like. At least some of the analytics may further indicate particular entities identified based on, e.g., a face of the entity. To this end, the reference multimedia content elements may include images showing faces of known criminals stored in, e.g., a criminal database, associated with analytics indicating the names of such criminals.

At optional S240, a profile may be created based on the determined analytics. Alternatively or collectively, an existing profile may be updated. For example, if the analytics indicate that a consumer has having taken a particular path within a store, a profile indicating the path may be created for the consumer. Additionally, the number of consumers who have taken a similar path through a store may be gathered and stored for future reference. The profile may be used for, e.g., subsequent identification of consumer patterns, preferences, or both. The profile may be specific to a particular consumer or group of consumers, or may be a profile indicating general trends of a plurality of consumers.

At S250, the determined analytics may be stored in, e.g., a database. In an embodiment, S250 may include storing the created profile.

At S260, it is checked whether additional input multimedia content elements are to be analyzed and, if so, execution continues with S220, where a new input multimedia content element is analyzed by generating one or more signatures; otherwise, execution terminates.

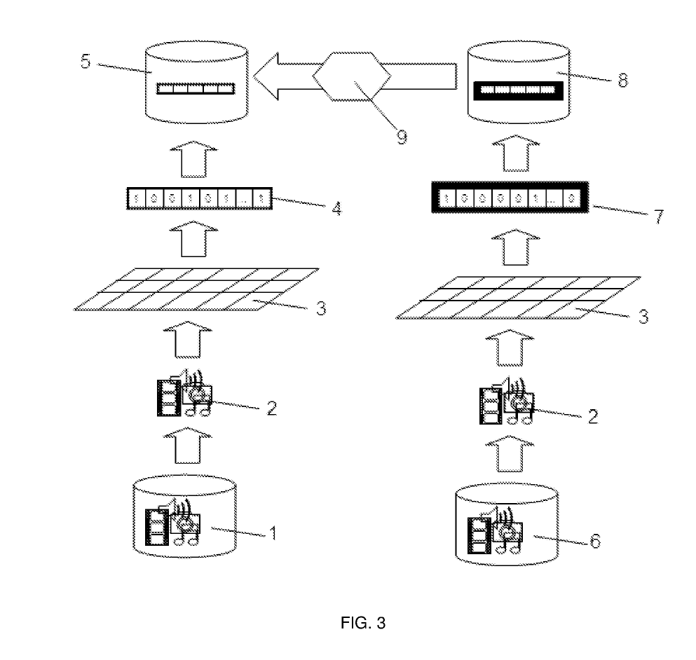

FIGS. 3 and 4 illustrate the generation of signatures for the multimedia content elements by the SGS 140 according to one embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment, the SGS 140 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the MMCE analyzer 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ } (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:

For: Vᵢ>TH_{RS} 1−p(V>Th_{S})−1−(1−ε)¹<<1 1:

i.e., given that l nodes (cores) constitute a Robust Signature of a certain image I, the probability that not all of these I nodes will belong to the Signature of same, but noisy image, Ĩ is sufficiently low (according to a system's specified accuracy).

p(Vᵢ>Th_{RS})≈l/L 2:

i.e., approximately l out of the total L nodes can be found to generate a Robust Signature according to the above definition.

Both Robust Signature and Signature are generated for certain frame i. 3:

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the above-referenced U.S. Pat. No. 8,655,801.

FIG. 5 is an example schematic diagram of the MMCE analyzer 130 according to an embodiment. The MMCE analyzer 130 includes a processing circuitry 510 coupled to a memory 520, a storage 530, and a network interface 540. In an embodiment, the components of the MMCE analyzer 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 610 may be realized as an array of at least partially statistically independent computational cores. The properties of each computational core are set independently of those of each other core, as described further herein above.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein. Specifically, the instructions, when executed, cause the processing circuitry 510 to determine analytics based on multimedia content elements as described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the MMCE analyzer 130 to communicate with the signature generator system 140 for the purpose of, for example, sending multimedia content elements, receiving signatures, and the like. Further, the network interface 540 allows the MMCE analyzer 130 to receive or retrieve input multimedia content elements, store analytics and profiles, and the like.

It should be understood that the embodiments described herein are not limited to the specific architecture illustrated in FIG. 5, and other architectures may be equally used without departing from the scope of the disclosed embodiments. In particular, the MMCE analyzer 130 may further include a signature generator system configured to generate signatures, an analytic generator configured to generate analytics for multimedia content elements based on signatures, or both, as described herein, without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining analytics based on multimedia content elements, comprising:
causing generation of at least one signature for at least one input multimedia content element, wherein each signature represents a concept, wherein each concept is a collection of signatures and metadata representing the concept;
comparing the generated at least one signature to a plurality of signatures of reference multimedia content elements to determine at least one matching reference multimedia content element, wherein each reference multimedia content element is associated with at least one predetermined analytic; and
determining, based on the comparison, at least one analytic, wherein the determined at least one analytic includes the at least one predetermined analytic associated with each matching reference multimedia content element.

2. The method of claim 1, further comprising:
creating a profile, wherein the profile includes the determined at least one analytic.

3. The method of claim 2, wherein the created profile indicates at least one consumer preference, wherein the at least one preference includes at least one of: preferences of a particular consumer, and general preferences of a plurality of consumers.

4. The method of claim 1, wherein the signatures of each matching reference multimedia content element match the at least one generated signature above a predetermined threshold.

5. The method of claim 1, wherein determining the at least one analytic further comprises:
sending, to a deep content classification system, at least one of: the at least one input multimedia content element, and the at least one signature generated for the at least one input multimedia content element;
receiving, from the deep concept classification system, at least one concept matching the input multimedia content element; and
creating at least one analytic based on the metadata representing the matching at least one concept, wherein the determined at least one analytic further includes the created at least one analytic.

6. The method of claim 1, wherein the at least one analytic includes at least one of: at least one movement, at least one interaction with an object, and at least one indication of a person.

7. The method of claim 5, wherein the at least one analytic includes: a path taken by an individual within a target area, at least one body movement, at least one movement within a target area, at least one facial movement, picking up an object, placing an object, and an indication of at least one criminal identified in a criminal database.

8. The method of claim 1, wherein each input multimedia content element is at least one of: an image, graphics, a video stream, a video clip, an audio stream, an audio clip, a video frame, a photograph, images of signals, and a portion thereof.

9. The method of claim 1, wherein each signature is generated by a signature generator system, wherein the signature generator system includes a plurality of at least partially statistically independent computational cores, wherein the properties of each core are set independently of the properties of each other core.

10. A non-transitory computer readable medium having stored thereon instructions for causing a processing circuitry to execute a process, the process comprising:
causing generation of at least one signature for at least one input multimedia content element, wherein each signature represents a concept, wherein each concept is a collection of signatures and metadata representing the concept;
comparing the generated at least one signature to a plurality of signatures of reference multimedia content elements to determine at least one matching reference multimedia content element, wherein each reference multimedia content element is associated with at least one predetermined analytic; and
determining, based on the comparison, at least one analytic, wherein the determined at least one analytic includes the at least one predetermined analytic associated with each matching reference multimedia content element.

11. A system for determining analytics based on multimedia content elements, comprising:
a processing circuitry; and
a memory, the memory containing instructions that, when executed by the processing circuitry, configures the system to:
cause generation of at least one signature for at least one input multimedia content element, wherein each signature represents a concept, wherein each concept is a collection of signatures and metadata representing the concept;
compare the generated at least one signature to a plurality of signatures of reference multimedia content elements to determine at least one matching reference multimedia content element, wherein each reference multimedia content element is associated with at least one predetermined analytic; and
determine, based on the comparison, at least one analytic, wherein the determined at least one analytic includes the at least one predetermined analytic associated with each matching reference multimedia content element.

12. The system of claim 11, wherein the system is further configured to:
create a profile, wherein the profile includes the determined at least one analytic.

13. The system of claim 12, wherein the created profile indicates at least one consumer preference, wherein the at least one preference includes at least one of: preferences of a particular consumer, and general preferences of a plurality of consumers.

14. The system of claim 11, wherein the signatures of each matching reference multimedia content element match the at least one generated signature above a predetermined threshold.

15. The system of claim 11, wherein the system is further configured to:
send, to a deep content classification system, at least one of: the at least one input multimedia content element, and the at least one signature generated for the at least one input multimedia content element;
receive, from the deep concept classification system, at least one concept matching the input multimedia content element; and
create at least one analytic based on the metadata representing the matching at least one concept, wherein the determined at least one analytic further includes the created at least one analytic.

16. The system of claim 11, wherein the at least one analytic includes at least one of: at least one movement, at least one interaction with an object, and at least one indication of a person.

17. The system of claim 15, wherein the at least one analytic includes: a path taken by an individual within a target area, at least one body movement, at least one movement within a target area, at least one facial movement, picking up an object, placing an object, and an indication of at least one criminal identified in a criminal database.

18. The system of claim 11, wherein each input multimedia content element is at least one of: an image, graphics, a video stream, a video clip, an audio stream, an audio clip, a video frame, a photograph, images of signals, and a portion thereof.

19. The system of claim 11, wherein each signature is generated by a signature generator system, wherein the signature generator system includes a plurality of at least partially statistically independent computational cores, wherein the properties of each core are set independently of the properties of each other core.
